(19) United States
(12) Patent Application Publication
(10) Pub. No.: US 2005/0151106 A1
(43) Pub. Date: Jul. 14, 2005

(54) Ceramic cartridge for a stop valve

(76) Inventor: Yong Qiang He, Fujian (CN)

Correspondence Address: Daniel N.Christus, Esq.;Wallenstein Wagner & Rockey, Ltd., 53rd Floor, 311 South Wacker Drive, Chicago, IL, 60606-6630, US

(21) Appl. No.: 10/753,936

(22) Filed: Jan. 8, 2004

(51) Int. Cl. F16K 5/10

(52) U.S. Cl. 251/208; 137/625.46; 137/625.31

(57) ABSTRACT

A quarter turn supply stop valve cartridge having ceramic disks for use in water supply lines is disclosed. The cartridge has a cartridge shell, a first ceramic disk comprising a first contact surface fixedly mounted in the cartridge shell, and a second ceramic disk comprising a second contact surface rotatably mounted in the cartridge shell. The second contact surface is in contact with the first contact surface. There is a plurality of apertures in the first ceramic disk. The second ceramic disk is rotatable in a single plane relative to the first ceramic disk, and is dimensioned to selectively vary the plurality of apertures between an opened state and a closed state such that when any of the plurality of apertures is in the opened state, the other of the plurality of apertures is in the same substantially identical opened state.

### TECHNICAL FIELD

This invention relates generally to a stop valve. More particularly, this invention relates to a quarter turn stop valve with ceramic disks in the valve cartridge.

### BACKGROUND OF THE INVENTION

Supply stop valves, also called cut-off valves, are used to stop the flow of water to a fixture, such as a faucet or a fill valve within the tank of a toilet. Stop valves are a commonly used valve in houses, with one such valve being installed in each of the water supply lines to a toilet and faucet. These stop valves are usually positioned between the wall and the fixture. Such stop valves can also be used to interrupt water flow to outside faucets, to prevent freezing of those faucets and their water supply lines during the coldest days of winter.

These supply stop valves are normally in an open position, and provide water to the faucet or fill valve from the water supply pipes of a home plumbing system. When either the faucet or the fill valve needs to be replaced or repaired, the closing of the supply stop valve shuts off the flow of water only to that faucet or fill valve. This permits the repair or replacement to be made without closing the main water supply valve that provides water to the rest of the house. In this way, the repair can be made without interrupting the water service to the rest of the house. Such stop valves can also be used to stop water flow to outside faucets, to prevent freezing of those faucets and their water supply lines during the coldest days of winter.

Stop valves are available in two basic styles: the angle stop valve and the straight stop valve. In the angle stop valve, the valve inlet and outlet are at approximate right angles to each other. In the straight stop valve, the valve inlet and outlet are coaxially aligned. Both the angle stop and the straight stop valves may be of the quarter-turn variety. Quarter-turn valves require a turn of the stem of only 90° to move its internal components from a fully opened to a fully closed position.

Valves must seal properly when closed to avoid contamination in water systems, which can cause valves to stick, or develop abrasions of the valve seats, resulting in more leakage. Leakage between the valve element and the valve seat is minimized by precision-machined surfaces, resulting in carefully controlled clearances. Most quarter turn stop valve cartridges use disks made of Teflon, nylon, polymers, or brass. Others use stainless steel balls (iron alloy with chrome, nickel, or other elements that do not oxidize in free air), both covered in and seated in Teflon.

There are several drawbacks to the use of these materials. Polymers or plastics have molecular structures that permit their deformation, sometimes permanently. Metals may also permanently deform, and add significant weight to valves in which they are used. The use of multiple and often dissimilar metal parts renders such valves prone to corrosion. Such corrosion can make the valves difficult to turn, or cause them to seize. This is particularly problematic for quarter turn stop valves, which are at times located in hard-to-reach places, such as under sinks and behind toilets, and are designed to be turned without the help of a wrench or other tool.

It is therefore the primary object of the present invention to provide an improved stop valve cartridge with enhanced airtightness that can be opened easily by a small force and is much less subject to permanent deformation, or to corrosion.

### SUMMARY OF THE INVENTION

One aspect of the present invention provides a cartridge for a supply stop valve having a cartridge shell. A first ceramic disk, comprising a first contact surface, is mounted in the cartridge shell. A second ceramic disk, comprising a second contact surface, is also mounted in the cartridge shell. The second contact surface abuts against and contacts the first contact surface.

A further aspect of the present invention provides a device for controlling the flow of fluid through a conduit having a cartridge shell. There is a first ceramic disk comprising a first contact surface fixedly mounted in the cartridge shell. The first ceramic disk includes a plurality of apertures. There is also a second ceramic disk comprising a second contact surface rotatably mounted in the cartridge shell. The second ceramic disk is dimensioned to selectively vary the size of the opening created by the plurality of apertures, as those apertures are moved between a fully opened state and a fully closed state. In particular, when any of the plurality of apertures is in a fully or partially opened state, the other of the plurality of apertures is in the same fully or partially opened state.

A still further aspect of the present invention is a device for controlling the flow of fluid through a conduit having a cartridge shell. There is a first ceramic disk comprising a first contact surface fixedly mounted in the cartridge shell, and a second ceramic disk comprising a second contact surface mounted in the cartridge shell. The second ceramic disk is rotatable in a single common plane relative to the first ceramic disk.

Other objects, advantages, and aspects of the present invention will become apparent upon reading the following description of the drawings and detailed description of the invention.

### BRIEF DESCRIPTION OF THE DRAWINGS

FIG. 1 is an exploded view of an angle stop valve.

FIG. 2 is a sectional view through the center of the angle stop valve of FIG. 1.

FIG. 3 is an exploded view of a straight stop valve.

FIG. 4 is a sectional view through the center of the straight stop valve of FIG. 3.

FIG. 5 is an exploded view of the cartridge assembly of the invention.

FIG. 6 is a partial sectional view of the cartridge assembly of the invention.

FIG. 7 is a bottom view, i.e., a view through the water supply inlet port, of an angle stop valve in a fully opened position.

FIG. 8 is a bottom view of an angle stop valve of FIG. 7 in a closed position.

FIG. 9 is a bottom view of an angle stop valve in a more than halfway open position.

FIG. 10 is a bottom view of an angle stop valve in a halfway open position.

FIG. 11 is a bottom view of an angle stop valve in a less than halfway open position.

### DETAILED DESCRIPTION OF A PREFERRED EMBODIMENT OF THE INVENTION

This invention may be made in many different forms. The following drawings and description describe a preferred embodiment of the invention. It will be understood that the description is to be considered as but one example of the principles of the invention. The description is not intended to limit the broadest aspect of the invention to the illustrated embodiment.

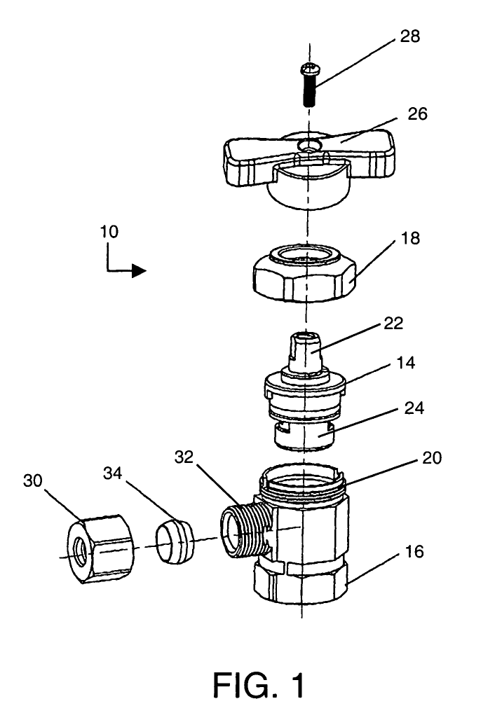

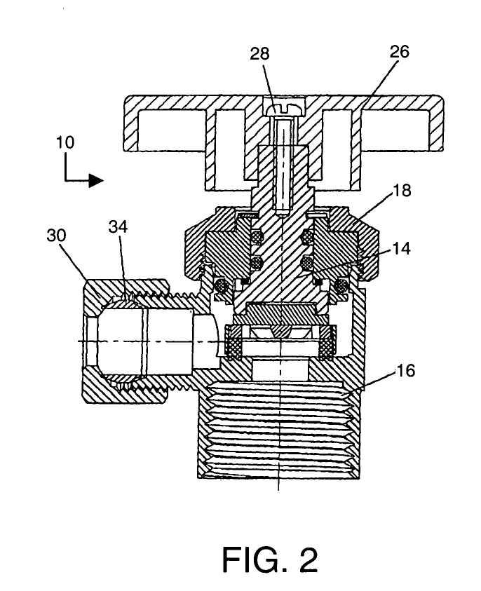

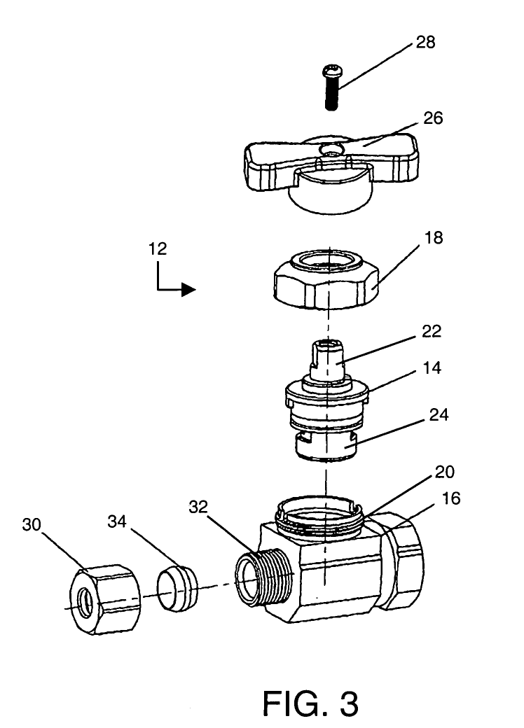

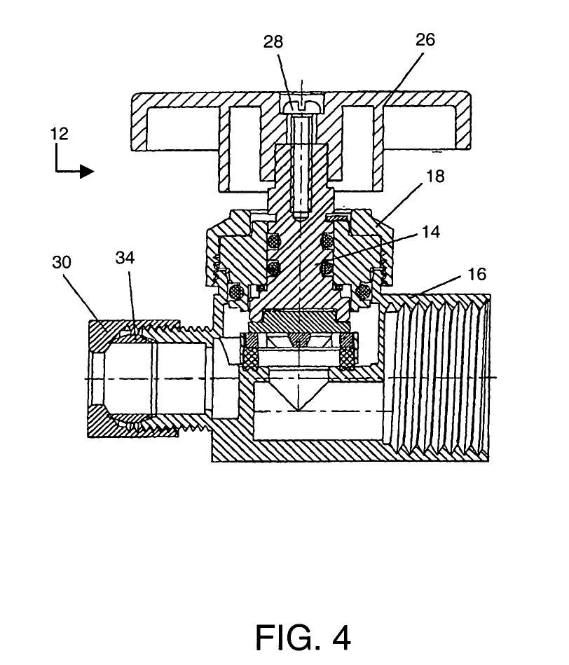

Referring to the drawings, FIG. 1 shows an exploded version of an angle stop valve 10 of the invention. FIG. 2 shows this same stop valve 10 fully assembled, in sectional view through the center of the valve. FIG. 3 shows an exploded view of the straight stop valve 12. FIG. 4 shows the same stop valve 10 as shown in FIG. 3, but fully assembled and in sectional view through the center of the valve. Because the same components are used in both the angle stop valve of FIGS. 1 and 2, and the straight stop valve of FIGS. 3 and 4, the same reference numerals are used to refer to the identical components in each of these four FIGURES.

FIGS. 1-4 show a cartridge assembly 14 that is housed within a valve body 16. A bonnet 18 is threadably secured onto a first threaded portion 20 of the body 16 to hold the cartridge assembly 14 in place.

The cartridge assembly 14 includes a stem 22 and a cartridge shell 24. A handle 26 is attached to the stem 22 by a screw 28. A nut 30 cooperates with a second threaded portion 32 on the body 16 to hold a sleeve 34 through which fluid can pass when the valve is open.

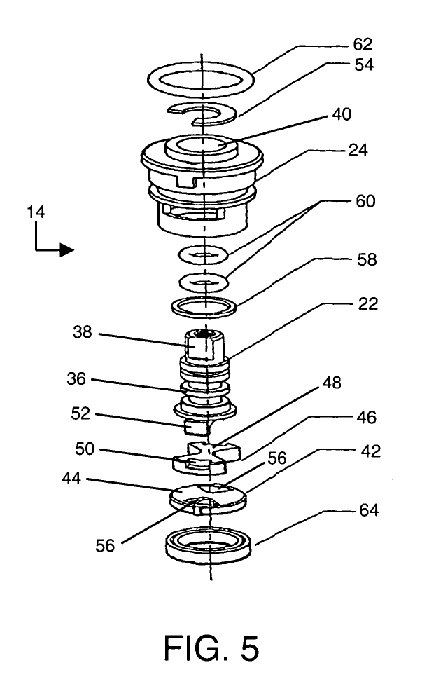

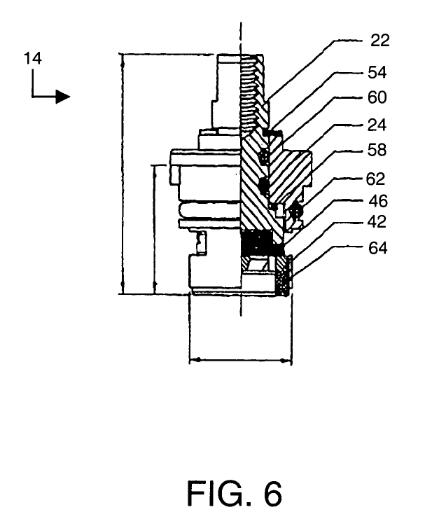

FIG. 5 shows an exploded view of the entire cartridge assembly 14. FIG. 6 depicts this same cartridge assembly 14 in its fully assembled configuration, and partially in section.

As can be seen in FIGS. 5 and 6, the stem 22 of the cartridge assembly 14 is inserted through the bottom of, and fits into, the cartridge shell 24. In its assembled state, a first portion 36 of the stem 22 is housed within the cartridge shell 24. In contrast, a second portion 38 of the stem 22 extends through an open end 40 of the cartridge shell 24 for attachment to the handle 26.

A first ceramic disk 42 comprising a first contact surface 44 is fixedly mounted in the cartridge shell 24. A second ceramic disk 46 comprising a second contact surface 48 is also mounted in the cartridge shell 24. The second ceramic disk 46 has two recessed portions 50, which mate with two keepers 52 that extend from the stem 22. A spring clip 54 engages an upper portion of the cartridge shell 24 when the bonnet 18 is screwed to the body 16. The spring clip 54 allows the stem 22, to rotate when the handle 26 is turned. When the stem 22 is rotated, the second ceramic disk 46 is also rotated in a single plane relative to the fixed first ceramic disk 42.

The fixed first ceramic disk 42 may have only a single aperture 56, or it may have a plurality of apertures 56, but the disk preferably has two apertures 56, as may best be seen in FIG. 5. In this embodiment, these apertures 56 are directly opposed, i.e., as may be seen in FIG. 5, the apertures 56 are positioned 180 degrees apart from each other on the disk 42. The rotatable second ceramic disk 46 rotates relative to the first disk 42. The second ceramic disk 46 is dimensioned so that as it rotates, it can partially or entirely obscure the apertures 56 of the first ceramic disk 42. In effect, the second ceramic disk 46 selectively varies the opening of the apertures 56. This in turn partially or fully opens the valve, and completely closes the valve.

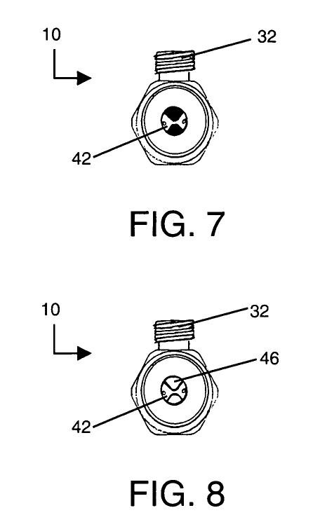

FIG. 7 shows an angle stop valve 10 of the present invention in a fully opened position. In this position, the second ceramic disk 46 does not obscure any part of the apertures 56. Each of the two apertures 56 has a shape similar to a 90 degree sector of a circle. Thus, when both apertures 56 are fully opened as shown in FIG. 7, the valve is in its fully opened position. Moreover, a total of about 180 degrees of the sector of a circle is opened, i.e., about half of the inner circular area shown in FIG. 7 is opened. In the fully opened position of the valve shown in FIG. 7, maximum flow of water through the valve is permitted.

In contrast, as may be seen in FIG. 8, the two apertures 56 are closed when the second ceramic disk 46 is rotated approximately 90 degrees from its position of FIG. 7. In this fully closed position of FIG. 8, virtually no water can pass through the valve.

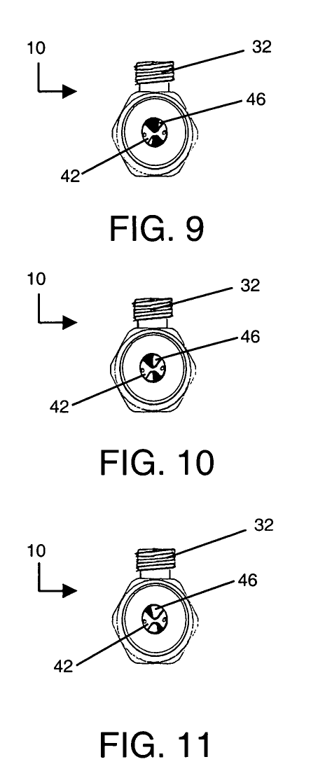

FIGS. 9 through 11 show the first 42 and second ceramic disks 46 moving relative to each other, in stages, to positions between the fully opened and the fully closed positions. For example, in FIG. 9, only a small part of each 90 degree sector (perhaps 15 degrees) is closed. In FIG. 10, about half of each 90 degree sector (about 45 degrees) is closed. In FIG. 11, about 75 degrees of each sector is closed or obscured. In the progression from FIG. 9 to FIG. 10 to FIG. 11, the valve becomes increasingly, progressively closed, i.e., a lesser amount of water can pass through the valve in the position of FIG. 10 than through the valve in the position of FIG. 9, and a lesser amount of water can pass through the valve in the position of FIG. 11 than through the valve in the position of FIG. 10.

As may also be seen from these FIGURES, because of the relationship of the first 42 and second ceramic discs 46, and the opposing relationship of the apertures 56, when one of the plurality of the apertures 56 is in a partially or fully opened state, the other of the plurality of apertures 56 is in the substantially identical partially or fully opened state. “Substantially identical,” for purposes of this disclosure, means that the amount that each of the plurality of apertures 56 is opened cannot differ by more than 10%, by area. This construction ensures that the water pressures in the angle stop valve 10 are fairly evenly distributed. This prevents premature and uneven wear.

The first ceramic disk 42 and the second ceramic disk 46 are preferably made of 96% aluminum oxide. Ceramics such as aluminum oxide are hard, brittle, and more resistant to high temperatures and severe environments than either metals or polymers. Therefore, ceramics will not deform. Moreover, ceramics are chemically inert, so they resist corrosion.

The first contact surface 44 contacts the second contact surface 48. When the handle 26 is turned, thereby rotating the stem 22 and the second ceramic disk 46, the valve is opened or closed.

The first contact surface 44 and the second contact surface 48 are polished to an average roughness of between 0.1 and 0.3 micrometers. Average roughness (Ra) is a common parameter for describing surface texture. Ra is calculated using an algorithm that measures the average length between the peaks and valleys on the surface, and the deviation from the mean line on the entire surface within the sampling length. Ra averages all of the peaks and valleys and then discards any outlying points, so that extreme points have no significant impact on the final result.

The first contact surface 44 and the second contact surface 48 may also be lubricated. A preferred lubricant comprises polydimethyl silicone. The lubrication and the fact that the first contact surface 44 and the second contact surface 48 are polished to an average roughness of between 0.1 and 0.3 micrometers, causes the first ceramic disk 42 and the second ceramic disk 46 to “stick” or adhere together. When the polished and lubricated first and second contact surfaces 44, 48 are pushed together, air is apparently forced out from between those surfaces 44, 48, and a vacuum is created between those surfaces 44, 48. This is similar to what occurs when one sets a cold drinking glass on a glass table. Condensation on the bottom of the glass causes the bottom of the drinking glass to “stick” to the table. The vacuum created between the first and second ceramic disks 42, 46 helps to prevent leakage of water past the first 42 and second disks 46.

Referring now to FIG. 6, a washer 58 and two stem O-rings 60 are annularly disposed about the first portion 36 of the stem 22. The washer 58 and the two stem O-rings 60 are housed inside the cartridge shell 24. A shell O-ring 62 is annularly disposed about the outside of the cartridge shell 24, and a seal washer 64 is disposed in the cartridge shell 24 adjacent the second ceramic disk 46. The O-rings 60, 62 and the washers 58, 64 help to ensure that the valve elements fit together snugly, as an aid to prevent leakage from the valve body.

While specific embodiments have been illustrated and described, numerous modifications are possible without departing from the spirit of the invention, and the scope of protection is only limited by the scope of the accompanying claims.

1. A cartridge for a supply stop valve, the cartridge comprising:
a cartridge shell;
a first ceramic disk comprising a first contact surface mounted in the cartridge shell; and
a second ceramic disk comprising a second contact surface mounted in the cartridge shell, the second contact surface being in contact with the first contact surface.

2. The cartridge of claim 1, wherein the ceramic is 96% aluminum oxide.

3. The cartridge of claim 1, wherein the first contact surface and the second contact surface are polished to an average roughness of between 0.1 and 0.3 micrometers.

4. The cartridge of claim 1 further comprising a lubricant lubricating the first contact surface and the second contact surface.

5. The cartridge of claim 4, wherein the lubricant comprises polydimethyl silicone.

6. The cartridge of claim 1, wherein the first ceramic disk is stationary and the second ceramic disk is rotatable in a single plane relative to the first ceramic disk.

7. The cartridge of claim 1, wherein the first ceramic disk has an aperture and the second ceramic disk is dimensioned to selectively open and close the aperture.

8. The cartridge of claim 7, wherein the aperture is closed when the second ceramic disk is rotated approximately 90 degrees relative to the first ceramic disk from a fully opened position.

9. The cartridge of claim 1 further comprising:
a plurality of apertures in the first ceramic disk, the second ceramic disk being dimensioned to selectively vary the plurality of apertures between an opened state and a closed state, wherein when any of the plurality of apertures is in the opened state, the other of the plurality of apertures is in the substantially identical opened state.

10. A device for controlling the flow of fluid through a conduit, the device comprising:
a cartridge shell;
a first ceramic disk comprising a first contact surface fixedly mounted in the cartridge shell;
a plurality of apertures in the first ceramic disk; and
a second ceramic disk comprising a second contact surface rotatably mounted in the cartridge shell, the second ceramic disk being dimensioned to selectively vary the plurality of apertures between an opened state and a closed state, wherein when any of the plurality of apertures is in the opened state, the other of the plurality of apertures is in the substantially identical opened state.

11. The device of claim 10, wherein the ceramic is 96% aluminum oxide.

12. The device of claim 10, wherein the second contact surface is in contact with the first contact surface, the first contact surface and the second contact surface being polished to an average roughness of between 0.1 and 0.3 micrometers.

13. The device of claim 10 further comprising a lubricant lubricating the first contact surface and the second contact surface.

14. The device of claim 13, wherein the lubricant comprises polydimethyl silicone.

15. The device of claim 10, wherein the second ceramic disk is rotatable in a single plane relative to the first ceramic disk.

16. The device of claim 15, wherein when the second ceramic disk is rotated approximately 90 degrees relative to the first ceramic disk from a fully opened state, the plurality of apertures are in the closed state.

17. A device for controlling the flow of fluid through a conduit, the device comprising:
a cartridge shell;
a first ceramic disk comprising a first contact surface fixedly mounted in the cartridge shell; and
a second ceramic disk comprising a second contact surface mounted in the cartridge shell, the second ceramic disk being rotatable in a single plane relative to the first ceramic disk.

18. The device of claim 17, wherein the ceramic is 96% aluminum oxide.

19. The device of claim 17, wherein the second contact surface is in contact with the first contact surface, the first contact surface and the second contact surface being polished to an average roughness of between 0.1 and 0.3 micrometers.

20. The device of claim 17 further comprising a lubricant lubricating the first contact surface and the second contact surface.

21. The device of claim 20, wherein the lubricant comprises polydimethyl silicone.

22. The device of claim 17 further comprising:
an aperture in the first ceramic disk, wherein the aperture can be selectively opened and closed by rotating the second ceramic disk.

23. The device of claim 22, wherein the aperture is closed when the second ceramic disk is rotated approximately 90 degrees relative to the first ceramic disk from a fully opened position.

24. The device of claim 17 further comprising:
a plurality of apertures in the first ceramic disk, the second ceramic disk being in contact with the first ceramic disk and dimensioned to selectively vary the plurality of apertures between an opened state and a closed state, wherein when any of the plurality of apertures is in the opened state, the other of the plurality of apertures is in the substantially identical opened state.
